(19) United States
(12) Patent Application Publication
(10) Pub. No.: US 2015/0256953 A1
(43) Pub. Date: Sep. 10, 2015

(54) SYSTEMS AND METHODS FOR ENHANCING PERFORMANCE OF AUDIO TRANSDUCER BASED ON DETECTION OF TRANSDUCER STATUS

(71) Applicant: Cirrus Logic, Inc., Austin, TX (US)

(72) Inventors: Nitin Kwatra, Austin, TX (US); John L. Melanson, Austin, TX (US)

(73) Assignee: Cirrus Logic, Inc., Austin, TX (US)

(21) Appl. No.: 14/200,458

(22) Filed: Mar. 7, 2014

(51) Int. Cl. H04R 29/00; H04R 3/00; H04R 1/10

(52) U.S. Cl. CPC H04R 29/00; H04R 1/10; H04R 3/002; H04R 2499/11; H04R 2499/15

(57) ABSTRACT

Based on transducer status input signals indicative of whether headphones housing respective transducers are engaged with ears of a listener, a processing circuit may determine whether the headphones are engaged with respective ears of the listener. Responsive to determining that at least one of the headphones is not engaged with its respective ear, the processing circuit may modify at least one of a first output signal to the first transducer and a second output signal to the second transducer such that at least one of the first output signal and the second output signal is different than such signal would be if the headphones were engaged with their respective ears.

### FIELD OF DISCLOSURE

The present disclosure relates in general to personal audio devices, and more particularly, to enhancing performance of an audio transducer based on detection of a transducer status.

### BACKGROUND

Wireless telephones, such as mobile/cellular telephones, cordless telephones, and other consumer audio devices, such as mp3 players, are in widespread use. Often, such personal audio devices are capable of outputting two channels of audio, each channel to a respective transducer, wherein the transducers may be housed in a respective headphone adapted to engage with a listener's ear. In existing personal audio devices, processing and communication of audio signals to each of the transducers often assumes that each headphone is engaged with respective ears of the same listener. However, such assumptions may not be desirable in situations in which at least one of the headphones is not engaged with an ear of the listener (e.g., one headphone is engaged with an ear of a listener and another is not, both headphones are not engaged with the ears of any listeners, headphones are simultaneously engaged with ears of two different listeners, etc.).

### SUMMARY

In accordance with the teachings of the present disclosure, the disadvantages and problems associated with improving audio performance of a personal audio device may be reduced or eliminated.

In accordance with embodiments of the present disclosure, an integrated circuit for implementing at least a portion of a personal audio device may include a first output, a second output, a first transducer status signal input, a second transducer status signal input, and a processing circuit. The first output may be configured to provide a first output signal to a first transducer. The second output may be configured to provide a second output signal to a second transducer. The first transducer status signal input may be configured to receive a first transducer status input signal indicative of whether a first headphone housing the first transducer is engaged with a first ear of a listener. A second transducer status signal input may be configured to receive a second transducer status input signal indicative of whether a second headphone housing the second transducer is engaged with a second ear of the listener. The processing circuit may be configured to, based at least on the first transducer status input signal and the second transducer status input signal, determine whether the first headphone is engaged with the first ear and the second headphone is engaged with the second ear. The processing circuit may further be configured to, responsive to determining that at least one of the first headphone is not engaged with the first ear and the second headphone is not engaged with the second ear, modify at least one of the first output signal and the second output signal such that at least one of the first output signal and the second output signal is different than such signal would be if the first headphone was engaged with the first ear and the second headphone was engaged with the second ear.

In accordance with these and other embodiments of the present disclosure, a method may include, based at least on a first transducer status input signal indicative of whether a first headphone housing a first transducer is engaged with a first ear of a listener and a second transducer status input signal indicative of whether a second headphone housing a second transducer is engaged with a second ear of the listener, determining whether the first headphone is engaged with the first ear and the second headphone is engaged with the second ear. The method may further include, responsive to determining that at least one of the first headphone is not engaged with the first ear and the second headphone is not engaged with the second ear, modifying at least one of a first output signal to the first transducer and a second output signal to the second transducer such that at least one of the first output signal and the second output signal is different than such signal would be if the first headphone was engaged with the first ear and the second headphone was engaged with the second ear.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example personal audio device, in accordance with embodiments of the present disclosure;

FIG. 1B is an illustration of an example personal audio device with a headphone assembly coupled thereto, in accordance with embodiments of the present disclosure;

FIG. 2 is a block diagram of selected circuits within the personal audio device depicted in FIGS. 1A and 1B, in accordance with embodiments of the present disclosure;

FIG. 3 is a block diagram depicting selected signal processing circuits and functional blocks within an example active noise canceling (ANC) circuit of a coder-decoder (CODEC) integrated circuit of FIG. 3, in accordance with embodiments of the present disclosure;

FIG. 4 is a block diagram depicting selected circuits associated with two audio channels within the personal audio device depicted in FIGS. 1A and 1B, in accordance with embodiments of the present disclosure;

FIG. 5 is a flow chart depicting an example method for modifying audio output signals to one or more audio transducers, in accordance with embodiments of the present disclosure; and

FIG. 6 is a another block diagram of selected circuits within the personal audio device depicted in FIGS. 1A and 1B, in accordance with embodiments of the present disclosure.

### DETAILED DESCRIPTION

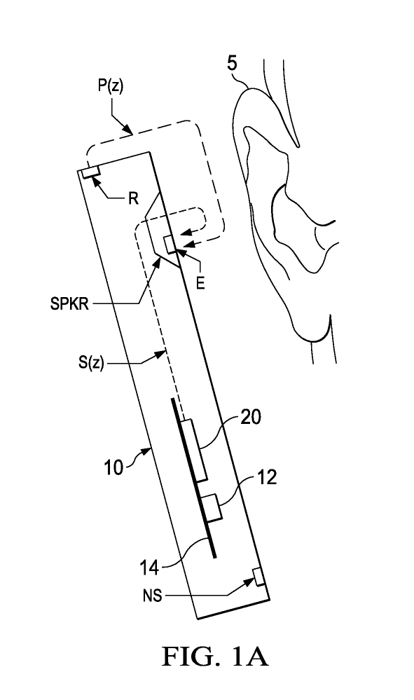

Referring now to FIG. 1A, a personal audio device 10 as illustrated in accordance with embodiments of the present disclosure is shown in proximity to a human ear 5. Personal audio device 10 is an example of a device in which techniques in accordance with embodiments of the invention may be employed, but it is understood that not all of the elements or configurations embodied in illustrated personal audio device 10, or in the circuits depicted in subsequent illustrations, are required in order to practice the invention recited in the claims. Personal audio device 10 may include a transducer such as speaker SPKR that reproduces distant speech received by personal audio device 10, along with other local audio events such as ringtones, stored audio program material, injection of near-end speech (i.e., the speech of the listener of personal audio device 10) to provide a balanced conversational perception, and other audio that requires reproduction by personal audio device 10, such as sources from webpages or other network communications received by personal audio device 10 and audio indications such as a low battery indication and other system event notifications. A near-speech microphone NS may be provided to capture near-end speech, which is transmitted from personal audio device 10 to the other conversation participant(s).

Personal audio device 10 may include adaptive noise cancellation (ANC) circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a listener's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when personal audio device 10 is in close proximity to ear 5. Circuit 14 within personal audio device 10 may include an audio CODEC integrated circuit (IC) 20 that receives the signals from reference microphone R, near-speech microphone NS, and error microphone E, and interfaces with other integrated circuits such as a radio-frequency (RF) integrated circuit 12 having a personal audio device transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of personal audio device 10 adapt an anti-noise signal generated out of the output of speaker SPKR from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to personal audio device 10, when personal audio device 10 is not firmly pressed to ear 5. While the illustrated personal audio device 10 includes a two-microphone ANC system with a third near-speech microphone NS, some aspects of the present invention may be practiced in a system that does not include separate error and reference microphones, or a personal audio device that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes. In addition, although only one reference microphone R is depicted in FIG. 1, the circuits and techniques herein disclosed may be adapted, without changing the scope of the disclosure, to personal audio devices including a plurality of reference microphones.

Referring now to FIG. 1B, personal audio device 10 is depicted having a headphone assembly 13 coupled to it via audio port 15. Audio port 15 may be communicatively coupled to RF IC 12 and/or CODEC IC 20, thus permitting communication between components of headphone assembly 13 and one or more of RF IC 12 and/or CODEC IC 20. As shown in FIG. 1B, headphone assembly 13 may include a combox 16, a left headphone 18A, and a right headphone 18B (which collectively may be referred to as “headphones 18” and individually as a “headphone 18”). As used in this disclosure, the term “headphone” broadly includes any loudspeaker and structure associated therewith that is intended to be held in place proximate to a listener's ear or ear canal, and includes without limitation earphones, earbuds, and other similar devices. As more specific non-limiting examples, “headphone” may refer to intra-canal earphones, intra-concha earphones, supra-concha earphones, and supra-aural earphones.

Combox 16 or another portion of headphone assembly 13 may have a near-speech microphone NS to capture near-end speech in addition to or in lieu of near-speech microphone NS of personal audio device 10. In addition, each headphone 18A, 18B may include a transducer such as speaker SPKR that reproduces distant speech received by personal audio device 10, along with other local audio events such as ringtones, stored audio program material, injection of near-end speech (i.e., the speech of the listener of personal audio device 10) to provide a balanced conversational perception, and other audio that requires reproduction by personal audio device 10, such as sources from webpages or other network communications received by personal audio device 10 and audio indications such as a low battery indication and other system event notifications.

Each headphone 18A, 18B may include a reference microphone R for measuring the ambient acoustic environment and an error microphone E for measuring of the ambient audio combined with the audio reproduced by speaker SPKR close to a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

As depicted in FIG. 1B, each headphone 18 may include an accelerometer ACC. An accelerometer ACC may include any system, device, or apparatus configured to measure acceleration (e.g., proper acceleration) experienced by its respective headphone. Based on the measured acceleration, an orientation of the headphone relative to the earth may be determined (e.g., by a processor of personal audio device 10 coupled to such accelerometer ACC).

As shown in FIG. 1B, personal audio device 10 may provide a display to a user and receive user input using a touch screen 17, or alternatively, a standard LCD may be combined with various buttons, sliders, and/or dials disposed on the face and/or sides of personal audio device 10.

The various microphones referenced in this disclosure, including reference microphones, error microphones, and near-speech microphones, may comprise any system, device, or apparatus configured to convert sound incident at such microphone to an electrical signal that may be processed by a controller, and may include without limitation an electrostatic microphone, a condenser microphone, an electret microphone, an analog microelectromechanical systems (MEMS) microphone, a digital MEMS microphone, a piezoelectric microphone, a piezo-ceramic microphone, or dynamic microphone.

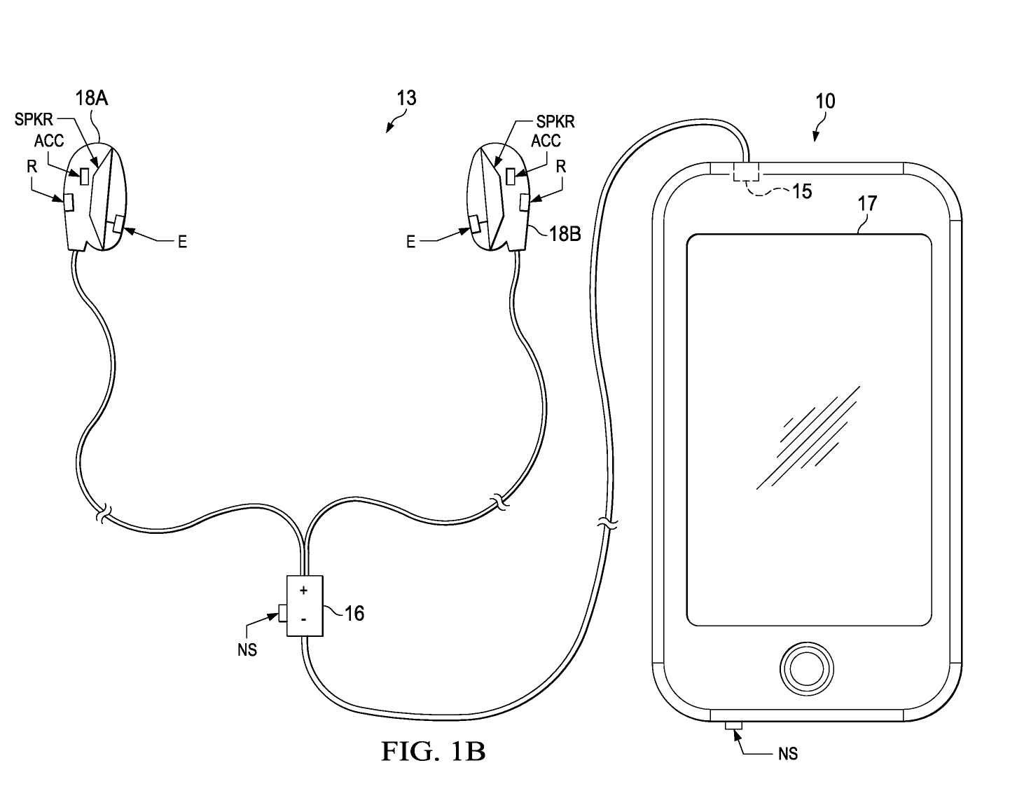

Referring now to FIG. 2, selected circuits within personal audio device 10, which in other embodiments may be placed in whole or part in other locations such as one or more headphone assemblies 13, are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals ia from internal audio sources 24, the anti-noise signal generated by ANC circuit 30, which by convention has the same polarity as the noise in reference microphone signal ref and is therefore subtracted by combiner 26, and a portion of near speech microphone signal ns so that the listener of personal audio device 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

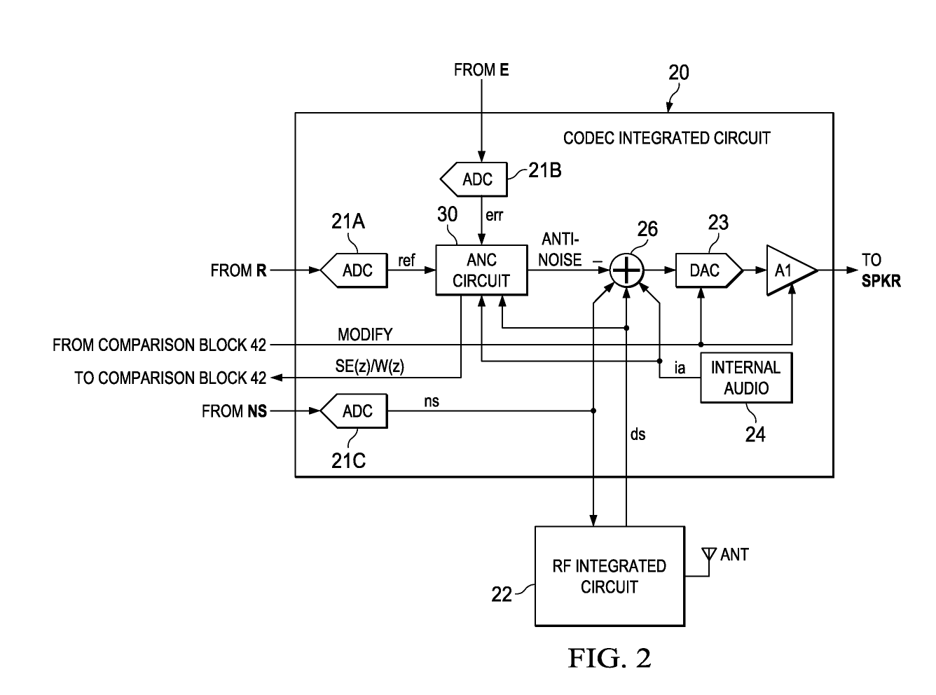

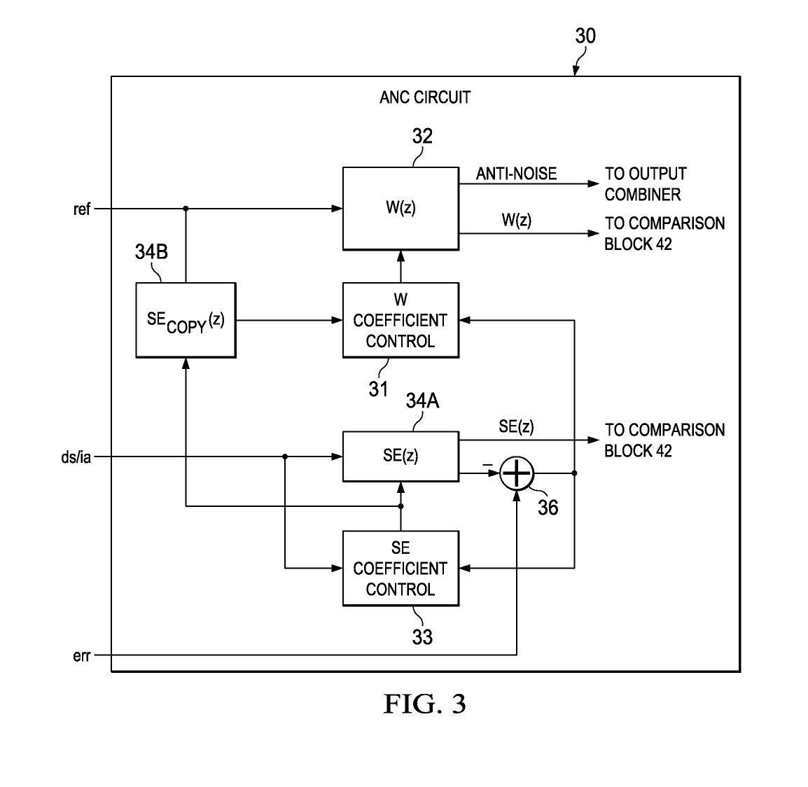

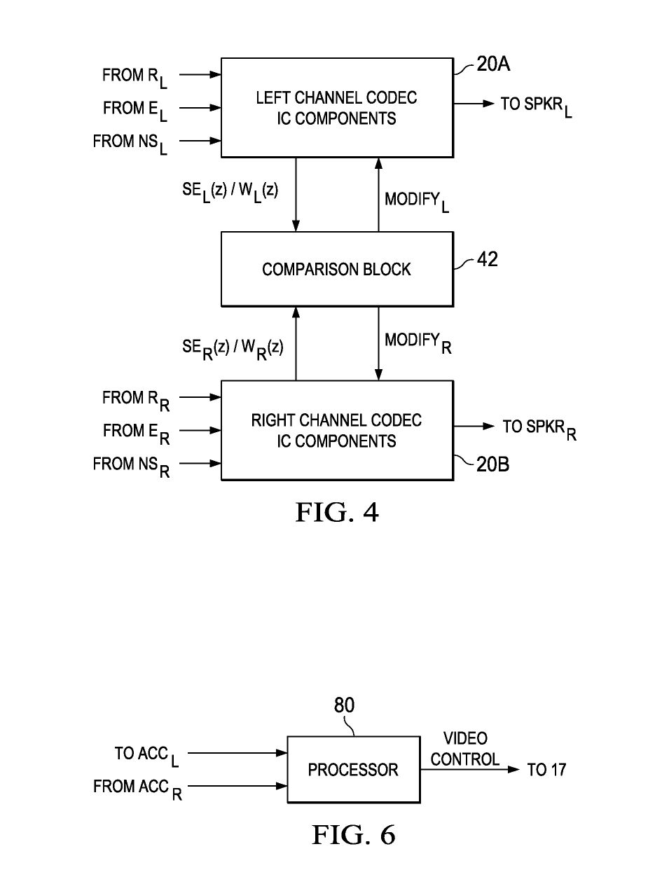

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err. By transforming reference microphone signal ref with a copy of the estimate of the response of path S(z), response SE_{COPY}(z), and minimizing the difference between the resultant signal and error microphone signal err, adaptive filter 32 may adapt to the desired response of P(z)/S(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a Copy. By Injecting an Inverted Amount of Downlink Audio Signal ds and/or internal audio signal ia, adaptive filter 32 may be prevented from adapting to the relatively large amount of downlink audio and/or internal audio signal present in error microphone signal err and by transforming that inverted copy of downlink audio signal ds and/or internal audio signal ia with the estimate of the response of path S(z), the downlink audio and/or internal audio that is removed from error microphone signal err before comparison should match the expected version of downlink audio signal ds and/or internal audio signal ia reproduced at error microphone signal err, because the electrical and acoustical path of S(z) is the path taken by downlink audio signal ds and/or internal audio signal ia to arrive at error microphone E. As shown in FIGS. 2 and 3, W coefficient control block 31 may also reset signal from a comparison block 42, as described in greater detail below in connection with FIGS. 4 and 5.

Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36. SE coefficient control block 33 correlates the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal en, contains the content of error microphone signal err that is not due to downlink audio signal ds and/or internal audio signal ia.

For clarity of exposition, the components of audio IC circuit 20 shown in FIGS. 2 and 3 depict components associated with only one audio channel. However, in personal audio devices employing stereo audio (e.g., those with headphones) many components of audio CODEC IC 20 shown in FIGS. 2 and 3 may be duplicated, such that each of two audio channels (e.g., one for a left-side transducer and one for a right-side transducer) are independently capable of performing ANC.

Turning to FIG. 4, a system is shown including left channel CODEC IC components 20A, right channel CODEC IC components 20B, and a comparison block 42. Each of left channel CODEC IC components 20A and right channel CODEC IC components 20B may comprise some or all of the various components of CODEC IC 20 depicted in FIG. 2. Thus, based on a respective reference microphone signal (e.g., from reference microphone R_{L} or R_{R}), a respective error microphone signal (e.g., from error microphone E_{L} or E_{R}), a respective near-speech microphone signal (e.g., from near-speech microphone NS_{L} or NS_{R}), and/or other signals, an ANC circuit 30 associated with a respective audio channel may generate an anti-noise signal, which may be combined with a source audio signal and communicated to a respective transducer (e.g., SPKR_{L} or SPKR_{R}).

Comparison block 42 may be configured to receive from each of left channel CODEC IC components 20A and right channel CODEC IC components 20B a signal indicative of the response SE(z) of the secondary estimate adaptive filter 34A of the channel, shown in FIG. 4 as responses SE_{L}(z) and SE_{R}(z), and compare such responses. Responses of the secondary estimate adaptive filters 34A may vary based on whether a headphone 18 is engaged with an ear, and responses of the secondary estimate adaptive filters 34A may vary between ears of different users. Accordingly, comparison of the responses of the secondary estimate adaptive filters 34A may be indicative of whether headphones 18 respectively housing each of the transducers SPKR_{L} and SPKR_{R} are engaged to a respective ear of a listener, whether one or both of such headphones 18 are disengaged from its respective ear of the listener, or whether headphones 18 are engaged with a respective ear of two different listeners. Based on such comparison, and responsive to determining that both of the headphones 18 are not engaged with respective ears of the same listener, comparison block 42 may generate to one or both of left channel CODEC IC components 20A and right channel CODEC IC components 20B a modification signal (e.g., MODIFY_{L}, MODIFY_{R}) in order to modify at least one of the output signals provided to speakers (e.g., SPKR_{L}, SPKR_{R}) by left channel CODEC IC components 20A and right channel CODEC IC components 20B, such that at least one of the output signals is different than such signal would be if both headphones 18 were engaged with respective ears of the same listener. In some embodiments, such modification may include modifying a volume level of an output signal (e.g., by communication of a signal to DAC 23, amplifier A1, or other component of a CODEC IC 20 associated with the output signal).

Although the foregoing discussion contemplates comparison of responses SE(z) of secondary estimate adaptive filters 34A and altering a response of an audio signals in response to the comparison, it should be understood that ANC circuits 30 may compare responses of other elements of ANC circuits 30 and alter audio signals based on such comparisons alternatively or in addition to the comparisons of responses SE(z). For example, in some embodiments, comparison block 42 may be configured to receive from each of left channel CODEC IC components 20A and right channel CODEC IC components 20B a signal indicative of the response W(z) of the adaptive filter 32A of the channel, shown in FIG. 4 as responses W_{L}(z) and W_{R}(z), and compare such responses. Responses of the adaptive filters 32 may vary based on whether a headphone 18 is engaged with an ear, and responses of the adaptive filters 32 may vary between ears of different users. Accordingly, comparison of the responses of the adaptive filters 32 may be indicative of a whether headphones 18 respectively housing each of the transducers SPKR_{L} and SPKR_{R} are engaged to a respective ear of a listener, whether one or both of such headphones 18 are disengaged from its respective ear of the listener, or whether headphones 18 are engaged with a respective ear of two different listeners. Based on such comparison, and responsive to determining that both of the headphones 18 are not engaged with respective ears of the same listener, comparison block 42 may generate to one or both of left channel CODEC IC components 20A and right channel CODEC IC components 20B a modification signal (e.g., MODIFY_{L}, MODIFY_{R}) in order to modify at least one of the output signals provided to speakers (e.g., SPKR_{L}, SPKR_{R}) by left channel CODEC IC components 20A and right channel CODEC IC components 20B, such that at least one of the output signals is different than such signal would be if both headphones 18 were engaged with respective ears of the same listener. In some embodiments, such modification may include modifying a volume level of an output signal (e.g., by communication of a signal to DAC 23, amplifier A1, or other component of a CODEC IC 20 associated with the output signal). In these and other embodiments, such modification may include switching each headphone from stereo mode to a mono mode, in which the output signals to each headphone are approximately equal to each other. In these and other embodiments, such modification may include switching each headphone from stereo mode to a mono mode, in which the output signals to each headphone are approximately equal to each other.

Although the foregoing discussion contemplates detection of whether headphones 18 are engaged with respective ears of the same listener or engaged with ears of different listeners performed by responses of functional blocks of ANC systems (e.g., filters 32A or 34A), any other suitable approach may be used to perform such detection.

As shown in FIG. 5, responsive to a determination of whether headphones 18 are engaged with respective ears of the same listener or engaged with ears of different listeners, output signals generated by a CODEC IC 20 may be modified depending on whether both headphones 18 are disengaged from the ears of a listener, only one headphone 18 is engaged with an ear of a single listener, or headphones 18 are engaged with respective ears of two different listeners. FIG. 5 is a flow chart depicting an example method 50 for modifying audio output signals to one or more audio transducers, in accordance with embodiments of the present disclosure. As noted above, teachings of the present disclosure may be implemented in a variety of configurations of personal audio device 10 and CODEC IC 20. As such, the preferred initialization point for method 50 and the order of the steps comprising method 50 may depend on the implementation chosen.

At step 52, comparison block 42 or another component of CODEC IC 20 may analyze responses SE_{L}(z) and SE_{R}(z) of secondary estimate adaptive filters 34A and/or analyze responses W_{L}(z) and W_{R}(z) of adaptive filters 32. At step 54, comparison block 42 or another component of CODEC IC 20 may determine if the responses SE_{L}(z) and SE_{R}(z) and/or responses W_{L}(z) and W_{R}(z) indicate that both of headphones 18 are not engaged with respective ears of the same listener. If the responses SE_{L}(z) and SE_{R}(z) and/or if responses W_{L}(z) and W_{R}(z) indicate that both of headphones 18 are not engaged with respective ears of the same listener, method 50 may proceed to step 58, otherwise method 50 may proceed to step 56.

At step 56, responsive to a determination that responses SE_{L}(z) and SE_{R}(z) and/or that responses W_{L}(z) and W_{R}(z) indicate that both of headphones 18 are engaged with respective ears of the same listener, audio signals generated by each of left channel CODEC IC components 20A and right channel CODEC IC components 20B may be generated pursuant to a “normal” operation. After completion of step 56, method 50 may proceed again to step 52.

At step 58, comparison block 42 or another component of CODEC IC 20 may determine if the responses SE_{L}(z) and SE_{R}(z) and/or responses W_{L}(z) and W_{R}(z) indicate that one headphone 18 is engaged with an ear of a listener while the other headphone is not engaged with the ear of the same listener or any other listener. If the responses SE_{L}(z) and SE_{R}(z) and/or responses W_{L}(z) and W_{R}(z) indicate that one headphone 18 is engaged with an ear of a listener while the other headphone is not engaged with the ear of the same listener or any other listener, method 50 may proceed to step 60. Otherwise, method 50 may proceed to step 64.

At step 60, responsive to a determination that the responses SE_{L}(z) and SE_{R}(z) and/or responses W_{L}(z) and W_{R}(z) indicate that one headphone 18 is engaged with an ear of a listener while the other headphone 18 is not engaged with the ear of the same listener or any other listener, a CODEC IC 20 or another component of personal audio device 10 may switch output signals to speakers SPKR_{L} and SPKR_{R} from a stereo mode to a mono mode in which the output signals are approximately equal to each other. In some embodiments, switching to the mono mode may comprise calculating an average of a first source audio signal associated with a first output signal to one speaker SPKR and a second source audio signal associated with a second output signal to the other speaker SPKR, and causing each of the first output signal and the second output signal to be approximately equal to the average.

At step 62, also responsive to a determination that the responses SE_{L}(z) and SE_{R}(z) and/or responses W_{L}(z) and W_{R}(z) indicate that one headphone 18 is engaged with an ear of a listener while the other headphone 18 is not engaged with the ear of the same listener or any other listener, a CODEC IC 20 or another component of personal audio device 10 may increase an audio volume for one or both of speakers SPKR_{L} and SPKR_{R}. After completion of step 62, method 50 may proceed again to step 52.

At step 64, comparison block 42 or another component of CODEC IC 20 may determine if the responses SE_{L}(z) and SE_{R}(z) and/or responses W_{L}(z) and W_{R}(z) indicate that both headphones 18 are not engaged to ears of any listener. If the responses SE_{L}(z) and SE_{R}(z) and/or responses W_{L}(z) and W_{R}(z) indicate that both headphones 18 are not engaged to ears of any listener, method 50 may proceed to step 66. Otherwise, method 50 may proceed to step 72.

At step 66, responsive to a determination that the responses SE_{L}(z) and SE_{R}(z) and/or responses W_{L}(z) and W_{R}(z) indicate that both headphones 18 are not engaged to ears of any listener, a CODEC IC 20 or another component of personal audio device 10 may increase an audio volume for one or both of speakers SPKR_{L} and SPKR_{R}.

At step 68, also responsive to a determination that the responses SE_{L}(z) and SE_{R}(z) and/or responses W_{L}(z) and W_{R}(z) indicate that both headphones 18 are not engaged to ears of any listener, a CODEC IC 20 or another component of personal audio device 10 may cause personal audio device 10 to enter a low-power audio mode in which power consumed by CODEC IC 20 is significantly reduced compared to power consumption when personal audio device 10 is operating under normal operating conditions.

At step 70, also responsive to a determination that the responses SE_{L}(z) and SE_{R}(z) and/or responses W_{L}(z) and W_{R}(z) indicate that both headphones 18 are not engaged to ears of any listener, a CODEC IC 20 or another component of personal audio device 10 may cause personal audio device 10 to output an output signal to a third transducer device (e.g., speaker SPKR depicted in FIG. 1A), wherein such output signal is derivative of at least one of a first source audio signal associated with the first output signal and a second source audio signal associated with the second output signal. After completion of step 70, method 50 may proceed again to step 52.

At step 72, comparison block 42 or another component of CODEC IC 20 may determine if the responses SE_{L}(z) and SE_{R}(z) and/or responses W_{L}(z) and W_{R}(z) indicate that both headphones 18 are engaged to respective ears of different listeners. If the responses SE_{L}(z) and SE_{R}(z) and/or responses W_{L}(z) and W_{R}(z) indicate that both headphones 18 are engaged to respective ears of different listeners, method 50 may proceed to step 74. Otherwise, method 50 may proceed to again step 52.

At step 74, responsive to a determination that the responses SE_{L}(z) and SE_{R}(z) and/or responses W_{L}(z) and W_{R}(z) indicate that both headphones 18 are engaged to respective ears of different listeners, CODEC IC 20 or another component of personal audio device 10 may permit customized independent processing (e.g., channel equalization) for each of the two audio channels. After completion of step 62, method 50 may proceed again to step 52.

Although FIG. 5 discloses a particular number of steps to be taken with respect to method 50, method 50 may be executed with greater or fewer steps than those depicted in FIG. 5. In addition, although FIG. 5 discloses a certain order of steps to be taken with respect to method 50, the steps comprising method 50 may be completed in any suitable order.

Method 50 may be implemented using comparison block 42 or any other system operable to implement method 50. In certain embodiments, method 50 may be implemented partially or fully in software and/or firmware embodied in computer-readable media.

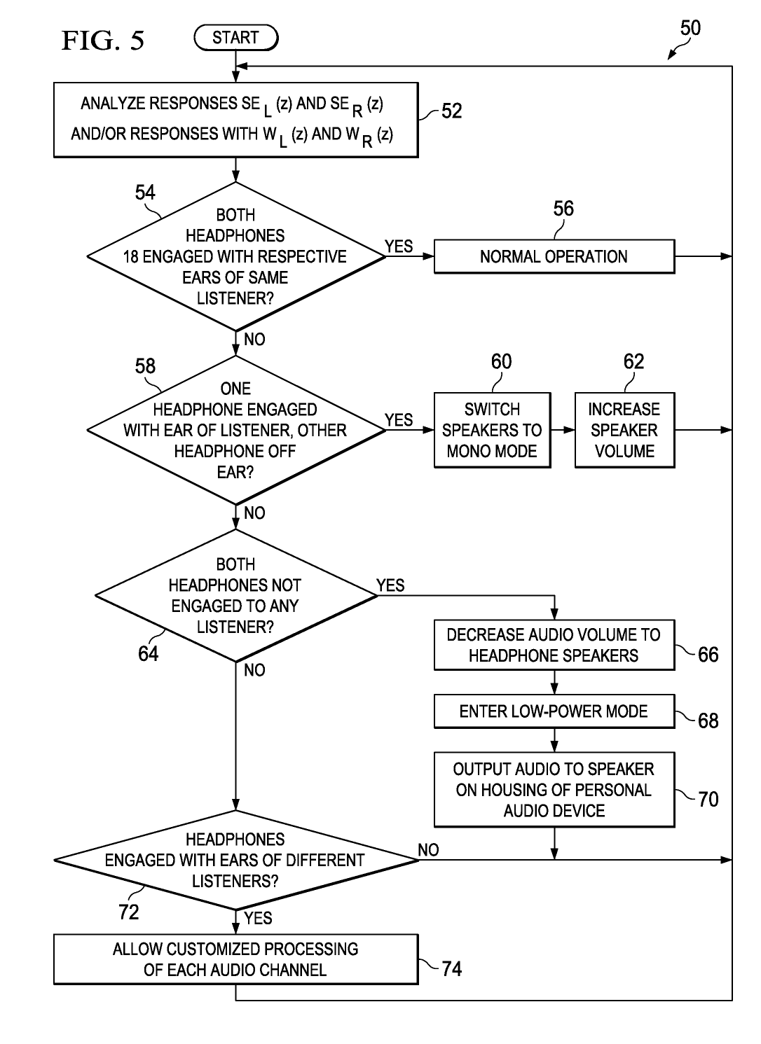

Referring now to FIG. 6, selected circuits within personal audio device 10 other than those shown in FIG. 2 are depicted. As shown in FIG. 6, personal audio device 10 may comprise a processor 80. In some embodiments, processor 80 may be integrated with CODEC IC 20 or one or more components thereof. In operation, processor 80 may receive orientation detection signals from each of accelerometers ACC of headphones 18 indicative of an orientation of at least one of the first headphone and the second headphone relative to the earth. When both headphones 18 are determined to be engaged with a respective ear of the same user, responsive to a change in orientation of at least one of the first headphone and the second headphone as indicated by the orientation detection signal, processor 80 may modify a video output signal comprising video image information for display to a display device of the personal audio device, for example, by rotating of an orientation of video image information displayed to the display device (e.g., between a landscape orientation and a portrait orientation, or vice versa). Accordingly, a personal audio device 10 may adjust a listener's view of video data based on an orientation of the listener's head, as determined by accelerometers ACC.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An integrated circuit for implementing at least a portion of a personal audio device, comprising:
a first output configured to provide a first output signal to a first transducer;
a second output configured to provide a second output signal to a second transducer;
a first transducer status signal input configured to receive a first transducer status input signal indicative of whether a first headphone housing the first transducer is engaged with a first ear of a listener;
a second transducer status signal input configured to receive a second transducer status input signal indicative of whether a second headphone housing the second transducer is engaged with a second ear of the listener; and
a processing circuit configured to:
based at least on the first transducer status input signal and the second transducer status input signal, determine whether the first headphone is engaged with the first ear and the second headphone is engaged with the second ear; and
responsive to determining that at least one of first headphone is not engaged with the first ear and the second headphone is not engaged with the second ear, modify at least one of the first output signal and the second output signal such that at least one of the first output signal and the second output signal is different than such signal would be if the first headphone was engaged with the first ear and the second headphone was engaged with the second ear.

2. The integrated circuit of claim 1, wherein the first transducer status signal comprises an error microphone signal indicative of an acoustic output of the first transducer and ambient audio sounds at the first transducer.

3. The integrated circuit of claim 1, wherein the processing circuit is further configured to implement:
a first secondary path estimate adaptive filter for modeling an electro-acoustic path of a first source audio signal through the first transducer and having a response that generates a first secondary path estimate signal from the first source audio signal;
a first coefficient control block that shapes the response of the first secondary path estimate adaptive filter in conformity with the first source audio signal and a first playback corrected error by adapting the response of the first secondary path estimate filter to minimize the first playback corrected error, wherein the first playback corrected error is based on a difference between a first error microphone signal and the first secondary path estimate signal;
a second secondary path estimate adaptive filter for modeling an electro-acoustic path of a second source audio signal through the second transducer and having a response that generates a second secondary path estimate signal from the second source audio signal;
a second coefficient control block that shapes the response of the second secondary path estimate adaptive filter in conformity with the second source audio signal and a second playback corrected error by adapting the response of the second secondary path estimate filter to minimize the second playback corrected error, wherein the second playback corrected error is based on a difference between the second error microphone signal and the second secondary path estimate signal;
a first filter that generates a first anti-noise signal to reduce a presence of ambient audio sounds at an acoustic output of the first transducer based at least on the first playback corrected error;
a second filter that generates a second anti-noise signal to reduce a presence of ambient audio sounds at an acoustic output of the second transducer based at least on the second playback corrected error; and
a comparison block that compares the response of the first secondary path estimate adaptive filter and the response of the second secondary path estimate adaptive filter and determines based on the comparison whether the first headphone is engaged with the first ear and the second headphone is engaged with the second ear.

4. The integrated circuit of claim 1, wherein modifying at least one of the first output signal and the second output signal comprises modifying the first output signal and the second output signal to be approximately equal to each other responsive to determining that either of the first headphone and the second headphone is not engaged with its respective ear.

5. The integrated circuit of claim 4, wherein modifying the first output signal and the second output signal to be approximately equal to each other comprises calculating an average of a first source audio signal associated with the first output signal and a second source audio signal associated with the second output signal, and causing each of the first output signal and the second output signal to be approximately equal to the average.

6. The integrated circuit of claim 1, wherein modifying at least one of the first output signal and the second output signal comprises increasing an audio volume of at least one of the first output signal and the second output signal responsive to determining that either of the first headphone and the second headphone is not engaged with its respective ear.

7. The integrated circuit of claim 1, wherein modifying at least one of the first output signal and the second output signal comprises decreasing an audio volume of at least one of the first output signal and the second output signal responsive to determining that both of the first headphone and the second headphone are not engaged with their respective ears.

8. The integrated circuit of claim 7, further comprising causing the personal audio device to enter a low-power mode responsive to determining that both of the first headphone and the second headphone are not engaged with their respective ears.

9. The integrated circuit of claim 1, wherein modifying at least one of the first output signal and the second output signal comprises outputting a third output signal to a third transducer device responsive to determining that both of the first headphone and the second headphone are not engaged with their respective ears, wherein the third output signal is derivative of at least one of a first source audio signal associated with the first output signal and a second source audio signal associated with the second output signal.

10. The integrated circuit of claim 1, wherein modifying at least one of the first output signal and the second output signal comprises allowing customized processing for each of the first output signal and the second output signal responsive to determining that either of the first headphone is engaged with the first ear and the second headphone is engaged with an ear of a second listener.

11. The integrated circuit of claim 1, further comprising:
an orientation detection signal input configured to receive an orientation detection signal indicative of an orientation of at least one of the first headphone and the second headphone relative to the earth; and
wherein the processing circuit is further configured to modify a video output signal comprising video image information for display to a display device of the personal audio device responsive to a change in orientation of at least one of the first headphone and the second headphone as indicated by the orientation detection signal.

12. The integrated circuit of claim 11, wherein modifying the video output signal comprises rotation of an orientation of video image information displayed to the display device.

13. A method, comprising:
based at least on a first transducer status input signal indicative of whether a first headphone housing a first transducer is engaged with a first ear of a listener and a second transducer status input signal indicative of whether a second headphone housing a second transducer is engaged with a second ear of the listener, determining whether the first headphone is engaged with the first ear and the second headphone is engaged with the second ear; and
responsive to determining that at least one of the first headphone is not engaged with the first ear and the second headphone is not engaged with the second ear, modifying at least one of a first output signal to the first transducer and a second output signal to the second transducer such that at least one of the first output signal and the second output signal is different than such signal would be if the first headphone was engaged with the first ear and the second headphone was engaged with the second ear.

14. The method of claim 13, wherein the first transducer status signal comprises an error microphone signal indicative of the output of the first transducer and ambient audio sounds at the first transducer.

15. The method of claim 13, further comprising:
comparing a response of a first secondary path estimate adaptive filter of a first adaptive noise cancellation system associated with the first transducer and a response of a second secondary path estimate adaptive filter of a second adaptive noise cancellation system associated with the second transducer; and
determining based on the comparison whether the first headphone is engaged with the first ear and the second headphone is engaged with the second ear.

16. The method of claim 13, wherein modifying at least one of the first output signal and the second output signal comprises modifying the first output signal and the second output signal to be approximately equal to each other responsive to determining that either of the first headphone and the second headphone is not engaged with its respective ear.

17. The method of claim 16, wherein modifying the first output signal and the second output signal to be approximately equal to each other comprises calculating an average of a first source audio signal associated with the first output signal and a second source audio signal associated with the second output signal, and causing each of the first output signal and the second output signal to be approximately equal to the average.

18. The method of claim 13, wherein modifying at least one of the first output signal and the second output signal comprises increasing an audio volume of at least one of the first output signal and the second output signal responsive to determining that either of the first headphone and the second headphone is not engaged with its respective ear.

19. The method of claim 13, wherein modifying at least one of the first output signal and the second output signal comprises decreasing an audio volume of at least one of the first output signal and the second output signal responsive to determining that both of the first headphone and the second headphone are not engaged with their respective ears.

20. The method of claim 19, further comprising causing the personal audio device to enter a low-power mode responsive to determining that both of the first headphone and the second headphone are not engaged with their respective ears.

21. The method of claim 13, wherein modifying at least one of the first output signal and the second output signal comprises outputting a third output signal to a third transducer device responsive to determining that both of the first headphone and the second headphone are not engaged with their respective ears, wherein the third output signal is derivative of at least one of a first source audio signal associated with the first output signal and a second source audio signal associated with the second output signal.

22. The method of claim 13, wherein modifying at least one of the first output signal and the second output signal comprises allowing customized processing for each of the first output signal and the second output signal responsive to determining that either of the first headphone is engaged with the first ear and the second headphone is engaged with an ear of a second listener.

23. The method of claim 13, further comprising:
receiving an orientation detection signal indicative of an orientation of at least one of the first headphone and the second headphone relative to the earth; and
modifying a video output signal comprising video image information for display to a display device of the personal audio device responsive to a change in orientation of at least one of the first headphone and the second headphone as indicated by the orientation detection signal.

24. The method of claim 23, wherein modifying the video output signal comprises rotation of an orientation of video image information displayed to the display device.
